(19) United States
(12) Patent Application Publication
(10) Pub. No.: US 2024/0348847 A1
(43) Pub. Date: Oct. 17, 2024

(54) APPARATUS AND METHOD FOR CONTROLLING DELIVERY OF BROADCAST CONTENT

(71) Applicant: Triveni Digital, Inc., Princeton, NJ (US)

(72) Inventor: Jimmy Rohit Gupta, Southampton, NJ (US)

(21) Appl. No.: 18/293,725

(22) PCT Filed: Aug. 4, 2022
(86) PCT No.: PCT/US2022/039362

§ 371 Date: Jan. 30, 2024

Related U.S. Application Data
(60) Provisional application No. 63/230,220, filed on Aug. 6, 2021.

(51) Int. Cl. H04N 21/24; H04N 21/2665

(52) U.S. Cl. CPC H04N 21/2402; H04N 21/2665

(57) ABSTRACT

A system and method for controlling delivery of broadcast content are described. They include a broadcast device configured to receive a first media stream from a first content source, provide the first media stream for broadcast transmission in a broadcast communication network while operating in a first operating mode. They further include a diagnostic device configured to monitor at least one characteristic of the quality of the first media stream from at least one location in the broadcast communication network, generate at least one control signal in response to a determination that a value for the at least one characteristic exceeds a threshold value, provide the at least one control signal over the broadcast communication network. The broadcast device is further configured to select a second operating mode in response to receiving at least one control signal, the second operating mode being different from the first operating mode.

### TECHNICAL FIELD

The present disclosure generally relates to the field of monitoring/diagnostic equipment and operations in communications systems. More particularly, the present disclosure is related to broadcast equipment, such as portable diagnostic devices, that are configured to operate with digital television (DTV) signals, especially advanced television systems committee (ATSC) compliant signals.

### BACKGROUND

Any background information described herein is intended to introduce the reader to various aspects of art, which may be related to the present embodiments that are described below. This discussion is believed to be helpful in providing the reader with background information to facilitate a better understanding of the various aspects of the present disclosure.

The advent of advanced broadcast signal transmission standards, such as the Advanced Television Systems committee (ATSC) 3.0 set of standards, and the corresponding transmission technologies makes manipulation of the data streams more difficult across broadcast content distribution networks than in previous networks that use legacy broadcast signal transmission standards, such as ATSC 1.0. Many television distribution networks using the advanced standards rely on a variety of technologies to move the media content that will ultimately constitute the television broadcast from the origination point, typically the main studio, to the transmission antenna.

The operators of the television broadcast facilities that provide signals into the broadcast content distribution networks need a way to verify that their digital broadcast signal (i.e., multiplex or data stream) is within standards described by one of several broadcast standards organizations, such as ATSC or any other applicable standard, in order to maintain interoperability. A data stream in a digital television (DTV) broadcast environment is very complex and is generated by a battery of equipment such as encoders, program and system information protocol (PSIP) generators, data servers, motion picture experts group (MPEG) standard MPEG-2 packet generators, multiplexers, etc.

A DTV signal represents a combination of multiple streams of data packets, i.e., it is a packet multiplex. A DTV system can include the transmission subsystem and the reception subsystem. Problems with such a DTV system can arise and as such monitoring and testing of the following is regularly done: (i) broadcast digital signal and the digital television broadcast equipment and (ii) reception and quality of the digital signal transmitted over the geographical area of coverage. This allows the user to detect various kinds of problems automatically as they occur, enabling rapid correction.

One problem with present broadcast transmission facility configuration and operating abilities is the difficulty associated with monitoring a plurality of aspects of the operation of the facility and external elements in the system. Further, there is often some delay in addressing any issues identified because the monitoring process only provides information and decision making often still requires additional review, often by a skilled technician. The resulting delays not only create undesirable downtime of the broadcast facility but also impact customer satisfaction due to unexpected interruptions in service. Therefore, there is a need for reduced downtime and improved quality of broadcast signal transmission by detecting issues with signals in the broadcast communication network and providing control information to modify the transmission of those signals.

### SUMMARY

According to one implementation, a system for controlling delivery of broadcast content is described. The system includes a broadcast device coupled to a broadcast communication network. The broadcast device is configured to operate in a first operating mode, the first operating mode including receiving a first media stream from a first content source and providing the first media stream for broadcast transmission. The system further includes at least one diagnostic device coupled to the broadcast communication network. The at least one diagnostic device is configured to receive the first media stream from at least one location in the broadcast communication network, monitor at least one characteristic of quality of the at least one media stream, generate at least one control signal in response to a determination that a value for the at least one characteristic exceeds a threshold value, and provide the at least one control signal to the broadcast gateway over the broadcast communication network. The broadcast device is further configured to operate in a second operating mode in response to receiving the at least one control signal, the second operating mode being different from the first operating mode.

According to another implementation, a method for controlling delivery of broadcast content is described. The method includes receiving a first media stream from a first content source and providing the first media stream for broadcast transmission in a broadcast communication network while operating in a first operating mode. The method also includes monitoring at least one characteristic of the quality of the first media stream from at least one location in the broadcast communication network, generating at least one control signal in response to a determination that a value for the at least one characteristic exceeds a threshold value, and providing the at least one control signal over the broadcast communication network. The method further includes selecting a second operating mode in response to receiving the at least one control signal, the second operating mode being different from the first operating mode.

### BRIEF DESCRIPTION OF THE DRAWINGS

The above and other aspects, features, and advantages of the present disclosure will become more apparent in light of the following detailed description when taken in conjunction with the accompanying drawings to which the principles of the present disclosure are applicable:

FIG. 1 is a block diagram of an exemplary broadcast content distribution system, according to aspects of the present disclosure;

FIG. 2 is a block diagram of an exemplary diagnostic device used in a signal communication system, according to aspects of the present disclosure;

FIG. 3 is a diagram of a exemplary gateway device used in a signal communication system, according to aspects of the present disclosure;

FIG. 4 is an exemplary signal diagnostic system used as part of a broadcast communication system, according to aspects of the present disclosure;

FIG. 5 is another exemplary signal diagnostic system used as part of a broadcast communication system, according to aspects of the present disclosure; and

FIG. 6 is a flow chart of an exemplary process for controlling delivery of broadcast content in a broadcast communication system, according to aspects of the present disclosure.

### DETAILED DESCRIPTION

It should be understood that the elements shown in the figures may be implemented in various forms of hardware, software, or combinations on one or more appropriately programmed general-purpose devices, which may include a processor, memory, and input/output interfaces. Those skilled in the art will be able to devise various arrangements which, although not explicitly described or shown herein, embody the principles of the disclosure and are included within its scope.

All examples recited herein are intended to aid the reader in understanding the principles of the disclosure and the concepts and are to be construed as being without limitation to such specifically recited examples and conditions. Any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor”, “module” or “controller” should not be construed to refer exclusively to hardware capable of executing software, and may implicitly include, without limitation, a system on a chip (SoC), digital signal processor (“DSP”) hardware, read only memory (“ROM”) for storing software, random access memory (“RAM”), and nonvolatile storage.

As used herein, the term “processor” broadly refers to and is not limited to a single- or multi-core general purpose processor, a special purpose processor, a processor, a Graphics Processing Unit (GPU), a DSP, a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), an SoC, and/or a state machine. As used herein, the terms “transaction” and “electronic transaction” broadly refer to any transaction which may be electronically validated by the recited system, method, and apparatus.

One or more of the aspects of the embodiments described above may be implemented using application-specific hardware. Further, one or more aspects of the embodiments may be implemented using one or more processing elements, such as central processing units (CPUs) that may include specific operating instructions embedded as firmware in the processing element(s) or may operate from software code that is downloaded into the elements from one or more memory units coupled to the processing element(s).

The present disclosure addresses issues related to maintaining or improving the quality of a broadcast transmission signal while also reducing downtime of the broadcast transmission. The issues are addressed by providing the ability to monitor characteristics of the signal using diagnostic devices coupled into the broadcast communication system at various points. The characteristics are used to generate control signals that can be provided to the various components in the broadcast communication system. The components may change their mode of operation as a result of the control signals. The change in the mode of operation may include, but is not limited to, adjusting broadcast transmission parameters for the signal and selecting an alternative or redundant signal to replace the present signal. As such, failure points for the signal can be detected and identified, and changes can be made to the operation of the broadcast communication system quickly and efficiently.

Advantages of the present disclosure will become more apparent from the detailed description given hereinafter. However, it should be understood that the detailed description and specific examples, while indicating preferred embodiments of the present disclosure, are given by way of illustration only, since various changes and modifications within the scope of the present disclosure will become apparent to those skilled in the art from this detailed description.

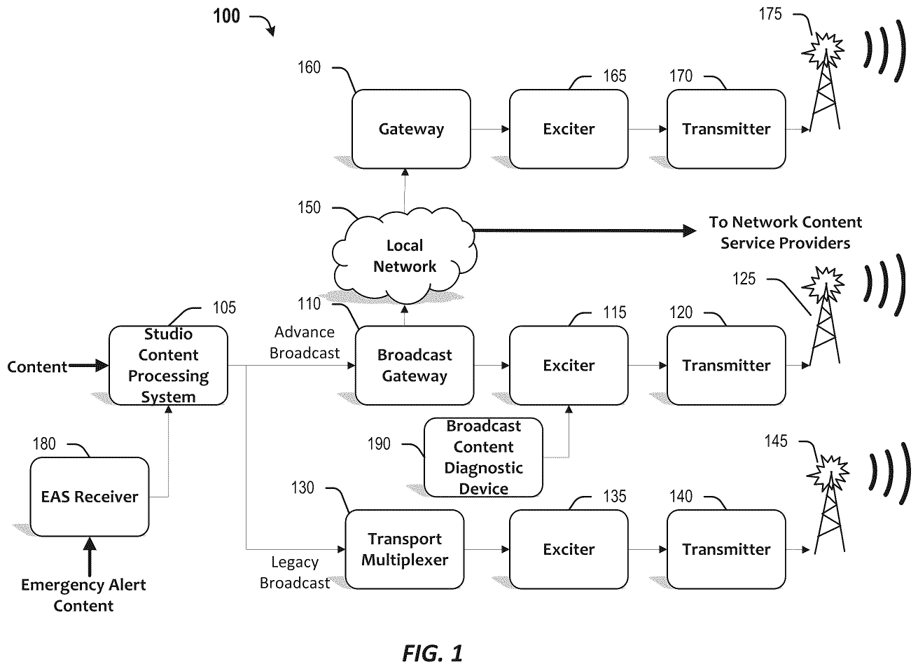

FIG. 1 illustrates a block diagram of an exemplary broadcast content distribution system 100 according to aspects of the present disclosure. In broadcast content distribution system 100, content from one or more content sources is provided to studio content processing system 105. Studio content processing system 105 is coupled to broadcast gateway 110. Broadcast gateway 110 is coupled to exciter 115. Exciter 115 is coupled to transmitter 120. Transmitter 120 is coupled to the transmitter antenna 125, which radiates a broadcast signal provided from transmitter 120 into the airwaves. Studio content processing system 105 is also coupled to transport multiplexer 130. Transport multiplexer 130 is coupled to exciter 135. Exciter 135 is coupled to transmitter 140. Transmitter 140 is coupled to the transmitter antenna 145, which radiates a broadcast signal provided from transmitter 140 into the airwaves. Broadcast gateway 110 is also coupled to gateway 160 through local network 150. Gateway 160 is coupled to exciter 165. Exciter 165 is coupled to transmitter 170. Transmitter 170 is coupled to the transmitter antenna 175, which radiates a broadcast signal provided from transmitter 170 into the airwaves. Local network 150 also interfaces with one or more network content service providers to provide data representing studio content to users of the network content services. Emergency alert content from one or more emergency alert sources is provided to emergency alert system (EAS) receiver 180. EAS receiver is coupled to studio content processing system 150. DTV diagnostic device 190 is coupled to ATSC 3.0 exciter 115.

Most broadcast signals, as well as many communication signals, rely on a set of standards in order to maintain compatibility between the signal transmission and the signal receivers used for receiving the signal transmission. Most standards further implement the communication structures within various elements and signals based on protocol layers, starting at the physical radio frequency (RF) layer, referred to as the physical (PHY) layer, and moving lower through to the network layer, transport layer, and finally, the lowest or application layer. Aspects of the present disclosure utilize the various relationships that can exist between various elements and signals of each of the protocol layers.

Nominally, the studio content processing system 105, broadcast gateway 110, exciter 115, transmitter 120, and antenna 125 are collocated (e.g., in the same building or facility) and represent a broadcast signal transmission mechanism for delivering broadcast signals for use by the public within a first geographic area. As such, the transmitter 120 is configured as the main or original transmission source of a broadcast signal. Further, the transport multiplexer 130, exciter 135, transmitter 140, and transmitter antenna 145 may also be collocated at or near the same geographic location and provide the same or similar broadcast signals but using a different transmission format. Additionally, gateway 160, exciter 165, transmitter 170, and transmitter antenna 175 may be collocated at a geographic location that is different from the location of the elements mentioned above and may represent a broadcast signal transmission mechanism for delivering broadcast signals for use by the public within a second or different geographic area using either the same or a different transmission format. It is worth noting that the configuration of broadcast content distribution system 100 represents one or many possible configurations which may take advantage of the principles of the present disclosure.

Media content (e.g., audio, video, and/or data signals) as well as data associated with the media content is received by studio content processing system 105. The studio content processing system 105 may include one or more devices for processing media content for delivery and/or transmission through broadcast content distribution system 100. The studio content processing system 105 may include, but is not limited to, encoders, packagers, signal converters, and the like. The media content may be provided from one or more media content sources including, but not limited to, content production studios, content distribution companies, broadcast content providers, and the like. Media content may also be provided from alternative content sources such as websites, content subscription service companies and interactive applications providers. Data content may also be provided by one or more of the above-mentioned content sources as well as from specific data content sources such as media content listing or content guide services companies. The media content and/or the data content may be provided as raw digital data that is unencoded and unencrypted, particularly with respect to any broadcast standard protocols. The studio content processing system 105 processes the media and data content from the various content sources to produce one or more content streams. The content streams may be encoded and/or compressed using one or more media content encoding or compression protocols including but not limited to, MPEG 2, MPEG-4, MPEG-4 advanced video coding (AVC), and MPEG-H Part-2 high efficiency video coding (HEVC). Some of these content streams may further be formatted into internal protocol packets based on any one of several possible network friendly protocols. For example, the streams may be formatted as Real-time Transport Protocol (RTP)/User Datagram Protocol (UDP)/internet protocol (IP) multicast streams as part of data source layer processing. In some embodiments using ATSC 3.0 transmission standards, the streams may be formatted as Real-time Object Delivery over Unidirectional Transport (ROUTE) or MPEG Media Transport (MMT) packets. Some of these multicast streams allow the IP packets destined for broadcast signal receivers to be tunneled through any IP network without need to provide special routing or other consideration for the receiver IP address space. Tunneling is a networking mechanism that allows data in any format across diverse networks. In some embodiments, the content streams are further formatted using a data source transport protocol (DSTP) as described in the ATSC standard A/324.

One or more of the content streams from studio content processing system 105 are provided to broadcast gateway 110 as part of an advance broadcast communication. Broadcast gateway 110 processes the one or more content streams and formats the signals into a broadcast signal transport stream. Broadcast gateway 110 processes one or more of several different types of elementary streams that may include packet formatting that is consistent with delivery as IP packets but can be adapted for delivery in a broadcast transport stream. As such, the processing in broadcast gateway 110 includes encapsulating and formatting the IP packets in the one or more content streams into link layer packets as part of a baseband data packet stream based on a specific transport protocol. In some embodiments, broadcast gateway 110 encapsulates the one or more content streams by adding a data link layer based on the ATSC Link Layer Protocol (ALP) described in ATSC Standard A/330 that carries the IP packets provided by studio content processing system 105 over the ATSC 3.0 broadcast standard physical layer. The encapsulation may further provide the mapping of some or all of the IP packets extracted from the content streams into sub-streams within the broadcast streams, often referred to as physical layer pipes (PLPs).

The processing in broadcast gateway 110 also includes packet management or scheduling in order to convert the broadcast signal transport stream into a stream containing baseband data packets suitable for processing by the exciter 115. The broadcast gateway 110 also generates a network configuration and control stream as well as a preamble stream as part of the scheduling operation. In some embodiments, the network configuration and control stream may be referred to as a timing and management control data stream. The broadcast signal transport stream, including the network configuration and control stream and preamble data stream, are used by exciter 115 to create the broadcast emission signal waveform. In some embodiments, one or more packets of the broadcast signal transport stream may be tunneled using a protocol such as the studio to link transport protocol (STLTP) as described in ATSC standard A/324 as part of an ATSC broadcast. Further, in some embodiments, the tunneled packets may include a security mechanism, such as a packet or stream signature, allowing exciter 115 to determine if the packet or stream has been tampered with. Information associated with packet or stream security associated with the present disclosure will be described in further detail below.

Exciter 115 receives the broadcast signal transport stream, along with the network configuration and control stream and preamble data stream, from the broadcast gateway and provides additional link layer signal processing to the streams to form the broadcast emission signal based on the network configuration and control stream and preamble data stream. The link layer signal processing may include one or more forms of data error correction encoding, temporal interleaving encoding, and data signal modulation. The data error correction encoding may include, but is not limited to, Reed-Solomon encoding, Viterbi encoding, Bahl, Cocke, Jelinek, and Raviv (BCJR) encoding, and low-density parity check (LDPC) encoding. The data signal modulation may include but is not limited to vestigial sideband (VSB) modulation, multi-level quadrature amplitude modulation (QAM), and multi-level orthogonal frequency modulation (OFDM). The resulting broadcast signal is converted from a digital format signal to an analog format baseband or low frequency signal and further upconverted to a frequency for transmission as analog transmission signal. In some embodiments the frequency for transmission may be in the very high frequency (VHF) range from 54 megahertz (MHZ) to 88 MHz and 174 MHz to 216 MHz or in the ultra-high frequency (UHF) range from 470 MHz to 868 MHz. The exciter 115 may also apply analog signal transmission precorrection to account for known or anticipated signal distortion caused by signal amplification in transmitter 120.

It is important to note that the link layer signal processing, data signal modulation, and signal up-conversion used by exciter 115 may conform to one or more of several broadcast signal physical layer broadcast standards. Such broadcast standards include, but are not limited to, ATSC 3.0, the digital video broadcasting (DVB) standard DVB-T2, and the integrated services broadcasting (ISDB) standard ISDB-T.

Transmitter 120 receives the analog transmission signal from exciter 115 and amplifies the signal from its received signal level of around one milliwatt (mW) to a level between one kilowatt (KW) and ten kW. Transmitter 120 may perform the amplification in stages and may include signal filtering between the stages as well as at the output in order to remove signal distortion artifacts and other undesired signal energy outside of the desired frequency range for the transmitted signal. It is worth noting that the type and amount of amplification and filtering that is used in transmitter 120 may affect the type and necessity for analog signal transmission precorrection that may be applied by exciter 115. The amplified RF transmission signal is provided to transmitter antenna 125 for emission as an over the air broadcast signal. The transmitter antenna 125 may include one or more antenna elements that are arranged and/or configured to provide the necessary or desired radiated emission pattern in order to provide the proper geographic cover area for the RF transmission signal. As illustrated, transmitter antenna 125 is incorporated as part of a communication tower that may be 50 or more feet tall. In some embodiments, transmitter antenna 125 may be incorporated as part of other structures including, but not limited to, a residential or commercial dwelling, a utility pole, a bridge, and the like.

One or more of the content streams from studio content processing system 105 are also provided to transport multiplexer 130 as part of a legacy broadcast communication. Transport multiplexer 130 operates in a similar manner to broadcast gateway 110 but is intended to process different types of content streams. More specifically, transport multiplexer 130 is configured to process one or more elementary broadcast signal streams having uniform packets that can be rearranged into a single broadcast transport stream while broadcast gateway 110 is configured, as described above, to process one or more content streams into different types of streams that are based on packet protocols such as transport control protocol/internet protocol (TCP/IP) and formats these stream into a complex broadcast signal transport stream. As such, the processing in transport stream multiplexer 130 includes identifying and, formatting and combining the one or more elementary content streams into a broadcast transport stream. The processing may also include program identification (PID) remapping as well as service remapping and generation and insertion of service information tables directly into the broadcast transport stream. In some embodiments, transport multiplexer 130 processes content streams consistent with the ATSC A/53 and A/73 standards.

Exciter 135 receives the broadcast signal transport stream from the transport multiplexer 130 and provides additional link layer signal processing to the streams to form the broadcast emission signal. The link layer signal processing may include one or more forms of data error correction encoding, temporal interleaving encoding, and data signal modulation similar to that described above for exciter 115. The resulting broadcast signal is converted from a digital format signal to an analog format baseband or low frequency signal and further upconverted to a frequency for transmission as analog transmission signal in transmitter 140 in a manner similar to that described above.

It is important to note that the link layer signal processing, data signal modulation, and signal up-conversion used by exciter 135 may conform to one or more of several broadcast signal physical layer broadcast standards. Such broadcast standards include, but are not limited to, ATSC 1.0 and DVB-T.

Transmitter 140 receives the analog transmission signal from exciter 135 and amplifies the signal to a level between one kW and ten kW as described above for transmitter 120. The amplified RF transmission signal is provided to transmitter antenna 145 for emission as an over the air broadcast signal. Transmitter antenna 145 may be configured and operates in a manner similar to that described for antenna 125 above. Further, in some embodiments, antenna 125 and antenna 145 may be incorporated as part of the same communication tower or other structure.

The broadcast signal transport stream, along with the network configuration and control stream and preamble data stream, from the broadcast gateway 110 is also provided through local network 150 to gateway 160. Local network 150 may be configured to deliver data as signals between various devices connected to local network 150 using an IP. The local network 150 may use various arrangements and other facilities or devices (not shown) to physically connect the devices together including, but not limited to, a microwave communications link, a high-speed fiber communications link, a lower speed copper wire communications link, and cellular or wi-fi communications link.

Gateway 160 processes the one or more baseband content streams and formats the streams into one or more broadcast signal transport streams for use by exciter 165. The processing in gateway 160 includes encapsulating and formatting the IP packets contained in the one or more content streams into link layer packets as part of the baseband streams used as part of the re-broadcast of the received signal based on a specific transport protocol as described above for broadcast gateway 110.

It is worth noting that the processing capability in gateway 160, which may be referred to as an edge gateway device, differs in several aspects to broadcast gateway 110. For example, it is not common or, in many cases, practical, to use broadcast gateway 110, and similar broadcast gateways, as an edge gateway device for internet type communication due to the fact that a broadcast transmission channel does not have available bandwidth for a return communication path across the broadcast network. Further, gateway 160, and similar edge gateways, typically provide routing functionality that require only support for validating a limited key signing security system while broadcast gateway 110, and similar broadcast gateways, are configured to support a private key signing security system, such as is used in many broadcast content transmission protocols, a function not typically employed as part of an edge gateway. Gateway 160, and similar edge gateways, also can be controlled using a management stream that is included as part of the data provided in the streaming content allowing unattended operation.

Exciter 165 receives the broadcast signal transport stream(s) containing the one or more content streams from the gateway 160 and provides additional link layer signal processing to the streams to form a broadcast emission signal and, finally, an analog transmission signal, for re-broadcast in a manner similar to that described above for exciter 115. The one or more baseband streams are similar to the content streams received from broadcast gateway 110, as described above, may include, among other elements, a network configuration and control stream and a preamble data stream. Transmitter 170 receives the analog transmission signal from exciter 165 and amplifies the signal in a manner similar to that described above for transmitter 120. The amplified RF transmission signal is provided to antenna 175 for emission over the air as described above for antenna 125. It is worth noting that the frequency that is used for the analog transmission signal in exciter 165 may be the same as, or different from, the frequency used for the analog transmission signal from exciter 115 depending on the signal transmission format and/or protocol used.

It is worth noting that the configuration in FIG. 1, that includes gateway 160, exciter 165, transmitter 170, and transmitter antenna 175, allows for a re-transmission of all or a portion of the broadcast signal transmitted by transmitter antenna 125 from transmitter 120. It is therefore expected that the geographic location of the transmission facility and the transmitter antenna 175 will be different from the geographic location of transmission facility and transmitter antenna 125.

EAS receiver 180 is configured to detect and receive emergency events that are broadcast as part of a separate network, such as the emergency broadcast network. If an emergency event is detected and received by EAS receiver 180, the information is provided to the studio content processing system 105. The studio content processing the system 105 processes the information and may insert the processed information into one or more of the content streams. In one embodiment, the processed information may be inserted into the secondary video and audio service portion of the broadcast signal transport stream.

Broadcast content diagnostic device 190 is capable of being coupled into a component, or broadcast device, in the broadcast content distribution system 100 and monitoring the signals passing into and/or out of the component. Broadcast content diagnostic device 190 may be coupled using a wireless connection and/or a wired connection. The monitored signals are further processed to perform signaling identification and verification, services and system table analysis, multicast data packet analysis, RF and other physical layer signal data analysis, rules event analysis, and electronic service guide (ESG) analysis. Further, broadcast content diagnostic device 190 provides a user input interface for selecting and controlling the monitoring and analysis functions. The broadcast content diagnostic device 190 also includes the capability to record and store the monitored signals along with the analysis functions. The broadcast content diagnostic device 190 may further the capability to display video or produce audio output through a GUI. The broadcast diagnostic device 190 also includes the capability to provide control signals to one or more of the other elements in broadcast content distribution system 100.

It is worth noting that while broadcast content diagnostic device 190 is shown in FIG. 1 as coupled to exciter 115, broadcast content diagnostic device 190 may be coupled and utilized at various points within the broadcast content distribution system 100 including, but not limited to, studio content processing system 105, transport multiplexer 130, gateway 160, and the like. Broadcast content diagnostic device 190 may also be utilized for receiving the transmitted broadcast signal at various points within the geographic region covered by the broadcast transmission. Further Information regarding operation of a diagnostic device, such as broadcast content diagnostic device 190, will be described in detail below.

In operation, media content is provided from a number of content sources to studio content processing system 105. Studio content processing system 105 processes the content streams to form one or more media streams. The media streams are further processed in various other components, or broadcast devices, in broadcast content distribution system 100 for delivery to either users or viewers as a broadcast transmission signal as part of operating in a first operating mode. For example, broadcast gateway 110 may receive a media stream from a first content source through studio content processing system 105 and provide the media stream for broadcast transmission through exciter 115, transmitter 120, and transmitter antenna 125, as part of a first operating mode. The media streams may also be processed in some of the broadcast devices in broadcast content distribution system 100 for delivery to network content service providers. The network content service providers may further deliver some or all of the media streams to users or viewers using an alternative content delivery method, such as a cable signal distribution network, IP streaming service, and the like.

The broadcast content diagnostic device 190 is configured to monitor and/or analyze the operation of various aspects of the broadcast devices described above along with any signals and data that are produced by, or communicated in the broadcast communication network between, those components. For example, the broadcast content diagnostic device 190 can be configured to access and/or receive one or more of the signals communicated and processed by a broadcast device, such as broadcast gateway 110 or exciter 115. The signals and/or data may collectively be referred to as media streams as almost all communication generated and communication between broadcast devices is formatted in some form of a media stream. The broadcast diagnostic device 190 monitors one or more characteristics associated with the quality or performance of the media streams to determine values for the characteristics. The broadcast diagnostic device 190 further generates one or more control signals in response to a determination that a value for a characteristic has exceeded a threshold value. The broadcast diagnostic device 190 provides the control signal(s) over the broadcast communication network for use by one or more of the broadcast devices in broadcast content distribution system 100 (e.g., broadcast gateway 110 or exciter 115).

One or more of the broadcast devices in broadcast content distribution system 100 may be configured to receive the control(s) signals provided over the broadcast communication network by the broadcast diagnostic device 190. The one or more broadcast devices can further be configured to operate in a second operating mode that is different from the first operating mode in response to receiving information in, or as part of, the control signal(s).

As described above, the broadcast content diagnostic device 190 may be coupled to various components in the broadcast content distribution system 100. The broadcast diagnostic device 190 may also be coupled at various points along the signal communication link between the various components. The place or position where the broadcast diagnostic device 190 is coupled into broadcast content distribution system 100 may be referred to as a location. In some embodiments, one or more of the components in broadcast content distribution system 100 may be at the same physical or geographic location while other components may be at different physical or geographic locations. For clarity purposes, the term location, as used herein, refers to the components, or signal communication points, themselves rather than the actual physical or geographic locations for those components or signal communication points.

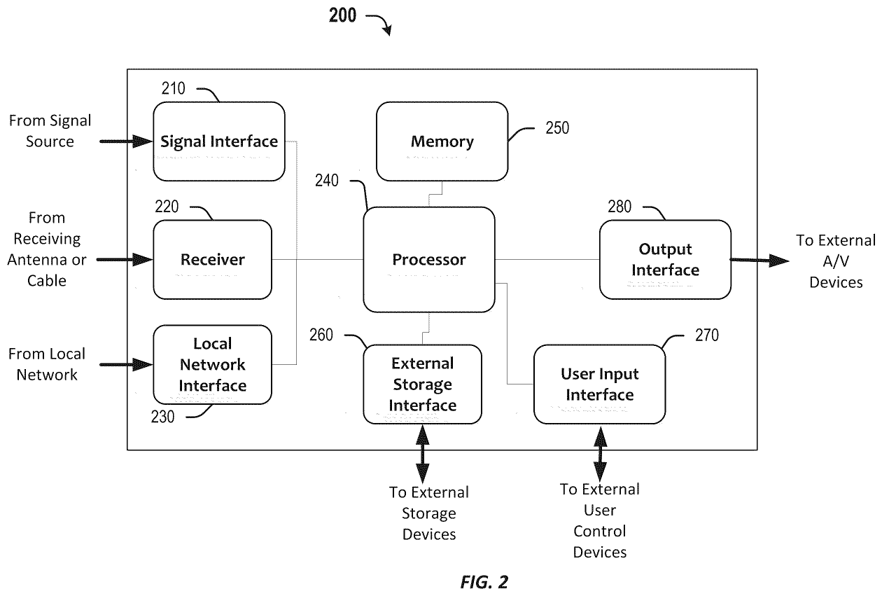

FIG. 2 illustrates a block diagram of an exemplary diagnostic device 200 according to aspects of the present disclosure. The diagnostic device 200 may operate in a manner similar to broadcast content diagnostic device 190 described in FIG. 1. The diagnostic device 200, which may also be referred to as a media stream analyzer, may be used in conjunction with monitoring the operations and signals in a broadcast content distribution system 100. Diagnostic device 200 may also be used as part of monitoring operations and signals in other content or information delivery systems or networks. Signals from a signal source (e.g., studio content processing system 105 in FIG. 1) are provided to signal interface 210. Signal interface 210 is coupled to processor 240. A signal that is transmitted or broadcast from a signal transmission device (e.g., antennas 125, 145, and/or 175) is provided to receiver 220. Receiver 220 is coupled to processor 240. A signal that is communicated on a local network (e.g., local network 150) is provided to local network interface 230. Signal interface 210, receiver 220, and local network interface are each coupled to processor 240. Processor 240 is coupled to memory 250. Processor 240 is also coupled to external storage interface 260 which communicates with external storage devices. Processor 240 is additionally coupled to user interface 270 which communicates with, and receives inputs from, external user control devices. Processor 240 is further coupled to output interface 280 which provides audio and/or video signals to external audio/visual (A/V) devices. It is worth noting that some elements or components that may be necessary for proper operation of diagnostic device 200 are not shown or described here for the sake of conciseness as they are well known to those skilled in the art.

Signal interface 210 receives signals through a direct connection to a device used in a signal communication system (e.g., studio content processing system 105, exciter 115, etc. in FIG. 1). Signal interface 210 may provide some signal processing, such as signal reformatting and analog to digital conversion, in order to provide the signals to processor 240 for analysis. Signal interface 210 may include one or physical interface components, such as Radio Communication of America (RCA) standard phone jacks, or other devices and circuits, such as asynchronous serial interface (ASI) and the society of motion picture and television engineers (SMPTE) 310.

Receiver 220 receives a broadcast signal through an externally connected RF receiver antenna (not shown) or through a coaxial cable connected to a broadcast cable network or device (not shown). The broadcast signal will have signal energy within a specific region or band of frequencies, typically between six and ten MHz in bandwidth, within the VHF and UHF range. The receiver 220 may include one or more suitable RF connectors, such as F-type connectors, mounted on the diagnostic device 200 for connecting to the RE receiver antenna and/or coaxial cable. The receiver 220 tunes and demodulates the broadcast signal to generate a signal that can be processed for analysis in processor 240. The tuner/demodulator 210 can be controlled to perform its processing based on a specific broadcast signal transmission protocol (e.g., ATSC 3.0, ATSC 1.0) using control signals from processor 240 based on selections and/or user inputs made through user interface 270. The components or elements used in receiver 220 may include, but are not limited to, filters, amplifiers, frequency downconverters, analog to digital signal converters, multi-phase multi-amplitude demodulators, error correction decoders, and the like. The components or elements may be combined or integrated into one or more larger components, such as integrated circuits or multi-chip modules. In some cases, one or more of the elements may be implemented as part of firmware or software in a digital signal processor.

Local network interface 230 provides a communication interface to a local network (e.g., local network 150 in FIG. 1) that is used in operation of a communication network (e.g., broadcast content distribution network 100). Local network interface 230 includes circuitry to perform signal processing functions for receiving signals that are present and being communicated between devices connected on the local network (e.g., broadcast gateway 110 and gateway 160). The received signals are decoded and provided to processor 240 as part of the monitoring and analysis operations. The signal processing functions in local network interface 230 may include protocol configuration used for operation on local networks, such as Ethernet or wireless networks. Local network interface 230 may also transmit data, such as protocol acknowledgments or access requests generated by processor 240 to the local network for delivery to one or more of the connected devices. Local network interface 230 also includes an interface connector suitable for the type of communication medium used with the local network. The interface connector may include, but is not limited to, an F-type coaxial connector, a straight tip (ST) type optical connector, a registered jack (RJ) type RJ-11 or RJ-45 connector, a mechanical transfer registered jack (MT-RJ) type connector, and the like. Local network interface 230 may also include one or more antennas that may be configured for use with wireless operation as part of the local network.

Processor 240 receives the one or more signals containing data and information from the signal interface 210, receiver 220, and/or local network interface 230. Processor 240 may further process the signal(s) to separate out groups of data packets from any sub-streams present in the signal(s). Processor 240 may separate packets that are intended for analysis and/or display based on, for instance, the selections made by a user or operator through user interface 270. Processor 240, may perform analysis on the one or more signals, such as averaging or correlation of various data and information in the signal(s). Processor 240 may also reformat any of the data, either received or generated, as needed for further processing in other components, such as output interface 280. For example, the data received may be in the form of a content stream for broadcast transmission and processor 240 may reformat the content stream for delivery to output interface as a high definition multimedia interface (HDMI) signal.

Processor 230 further receives status information as well as information about any received signals from sign interface 210, receiver 220, and/or local network interface 230, processes the information, and provides any control command information back to those elements. Processor 230 may also receive control instructions for specific operations for monitoring and analysis to be performed by diagnostic device 200 from external devices (e.g., through local network interface 230) in the broadcast signal distribution system (e.g., another diagnostic device). Processor 230 processes the control instructions and provides the necessary control information to the various elements in diagnostic device 200 to perform the specific operations.

It is worth noting that processor 240 may be embodied using a programmable microprocessor that is reconfigurable with downloadable instructions or software code stored in memory 250. Processor 240 may alternatively be a specifically programmed processing circuit configured as a signal and data processor as well as a controller with internal control code for controlling, managing, and processing all functions and data in diagnostic device 200. Further, one or more of the elements described in transceiver 200 may be combined into a larger component and may be implemented as a programmable microprocessor or as a specifically programmed processing circuit.

Memory 250 supports the operation of processor 240, as well as the other elements of diagnostic device 200, by storing and retrieving programming instructions and data associated with the control and operation of the diagnostic device 200. Memory 250 may also store and retrieve one or signals received through signal interface 210, receiver 220, and/or local network interface 230, during processing and analysis in processor 240. Memory 250 may include one or more of the following storage elements including, but not limited to, RAM, ROM, Electrically Erasable Programmable ROM (EEPROM), and flash memory. Memory 250 may also encompass one or more integrated memory elements including, but not limited to, magnetic media hard disk drives and optical media disk drives, that are housed with diagnostic device 200.

External storage interface 260 provides an interface to connect external storage devices (not shown) to diagnostic device 200 for additional storage capability. The external storage interface 260 may process the data signals in order to facilitate data transfer between the external storage devices and processor 240. The additional storage may be necessary, for instance, for capturing and storing, or recording, large portions of one or more signals or elements present in the signal communication system (e.g., broadcast content distribution system 100 in FIG. 1) for present or later review and further analysis. The external storage devices may include, but are not limited to, electronic flash storage drives, magnetic media hard disk drives, and optical media disk drives. External storage interface 260 may include the physical connectors as well as circuitry for using one or more of the various signal protocols associated with storage devices including, but not limited to, universal serial bus (USB) and personal computer memory card international association (PCMCIA).

User interface 270 provides a mechanism for receiving inputs from a user in order to facilitate control and operation of diagnostic device 200. User interface 270 may include a user input or entry mechanism, such as a set of buttons, a keyboard, or a microphone. User interface 270 may also include circuitry for converting user input signals into a data communication format to provide to processor 240. User interface 270 may further include some form of user notification mechanism to show device functionality or status, such as indicator lights, or small display. User interface 270 may also include circuitry for converting data received from processor 240 into signals that may be used to operate the user notification mechanism.

Output interface 280 allows connection to one or more audio and/or video reproduction devices (not shown), such as a display device, display monitor, television, audio speakers and the like. Output interface receives an audio and/or video signal that has been generated in processor 240 and processes the signal(s) for delivery to the reproduction device. Output interface 280 may include additional signal processing circuitry including, but not limited to, digital to analog converters, signal filters, digital and/or analog signal format converters, modulators, and the like. Output interface also includes one or more physical connectors to connect to the audio/video reproduction device using one or more of several different types of audio/video connecting cables. The one or more physical connectors may include, but are not limited to, RCA or phone type connectors, HDMI connectors, digital visual interface (DVI) connectors, Sony/Philips digital interface (S/PDIF) connectors, Toshiba Link (Toslink) connectors, and F-type coaxial connectors.

Diagnostic device 200 performs three main functions as a part of a signal communication system, inputting of media streams, monitoring, and analysis of those media streams, and providing results of the monitoring analysis to audio/visual devices for use by an operator or technician as well as other devices in the communication system. Diagnostic device 200 includes the capability to receive signals and media streams in multiple formats, including elementary streams and service streams (e.g., Route/MMTP, MPEG-2, Ethernet, and the like), transport layer streams (e.g., broadcast transport, STLTP, ALP, and the like), and RF or physical layer streams or signals (e.g., ATSC 1.0 broadcast, ATSC 3.0 broadcast, and the like), as well as IP signals created at any of these layers. Diagnostic device 200 can monitor any one of these media streams from any of these layers that are received at one of the inputs (e.g., signal interface 210, receiver 220, and local network interface (230). The diagnostic device 200 can further perform analysis on many of the media streams as well as validate many of the data structures and formatting based on various signal standards (e.g., ATSC 1.0, ATSC 3.0, and the like). The diagnostic device 200 can further analyze and validate various data tables, schedules, and program data, found in the media streams including, but not limited to, service map table (SMT), service list table (SLT), service layer signaling (SLS), extended file delivery table (EFDT), electronic service guide (ESG), and the like. The diagnostic device can additionally map and analyze information and data contained in the media streams that is configured using multicast IP.

The diagnostic device 200 further includes the capability to produce analysis outputs that may be provided to other broadcast devices based on rules or rule sets for various characteristics associated with the signals or media streams. The rules or rule sets may be input by the technician or operator (e.g., through user input interface) or may be pre-loaded into diagnostic device 200. The use of rules as part of analysis and outputs will be described in further detail below.

The diagnostic device 200 additionally includes the capability to provide real-time video and audio streams representing signals at any of the layers (e.g., elementary stream or service, transport, and physical layers) including displaying the video portion of a media stream as a series of thumbnails. The diagnostic device 200 also includes the capability to record and manage some or all of the media streams (e.g., using an external storage device connected to external storage interface 260) using a stream capture tool such as packet capture (PCAP). The diagnostic device 200 can also generate and provide for display the status (such as frequency of occurrence, object buffering of any indicators, tables, or maps for the signals as either a data table or in some type of graphical representation.

The diagnostic device 200 further includes user friendly features including color mapping as part of displaying multiple signals or media streams simultaneously, the capability to import and export configuration files to other diagnostic devices, and user management control tools that facilitate remote access to the information and data that has been input to, or stored in, diagnostic device 200.

In operation, one or more signals containing one or more media streams is accessed or received at signal interface 210, receiver 220, and/or local network interface 230. The signal(s) may be accessed or received at any one of the locations in the signal communication system (e.g., at a component, at a signal communication link coupling the components, or at a separate geographic location). The media streams may be a lower level type signal (e.g., an audio stream, a video stream, PSIP stream, an IP stream, and the like) or may be a higher level more complex type signal (e.g., a radio frequency broadcast signal, a transport stream, a service stream, and the like). In one embodiment, the signal communication system is a broadcast communication system, such as broadcast content distribution system 100 in FIG. 1 and the received media streams are DSTP streams that comply with the ATSC 3.0 standard. The signal(s) are provided to the processor 240 in order to process for analysis.

The processor 240, as part of processing the received signal(s), identifies and/or selects one or more characteristics associated with the one or more media streams. The selection may be made by the processor 240 in response to an input from an operator or technician made through user input interface 270. The selected characteristics are monitored to generate values for the characteristics. The processor 240 may also generate for display, through output interface 280, one or more display elements in a graphic user interface (GUI). The processor 240 may further generate one or more control signals based on a comparison of values generated for the characteristics to one or more threshold values. The control signals may be provided to one or more of the communication devices in a communication network (e.g., broadcast gateway 110 or exciter 115 in broadcast content distribution system 100).

In some embodiments, diagnostic device 200 may receive and monitor a first media stream and a second media stream. The second media stream may have its one or more characteristics monitored at a second location that is different from the first location used for monitoring the one or more characteristics of the first media stream. In some embodiments, the first media stream and the second media stream may even be the same media stream received from a single source but accessed and monitored at different points in the broadcast transmission path within the broadcast communication network. It is worth noting that several mechanisms exist for monitoring characteristics for media streams at more than one location using diagnostic device 200. For instance, a signal containing the first media stream may be received from a signal source at a first location (e.g., studio content processing system 105 in FIG. 1) and another signal containing the second media stream may be received from a transmission source (e.g., transmitter antenna 125) at a second location. Although these signals originate from two different physical or geographic locations, the signals may be monitored by the diagnostic device 200 through one or more of the signal communication links (e.g., wired or wireless) in the signal communication system (e.g., broadcast content distribution system 100 in FIG. 1). As described earlier, the location that the monitoring is performed is not restricted to a physical or geographic location but instead refers to a location of a component or communication link within the signal communication system.

In some embodiments, the generation of control signals may be based on the rules that are used to evaluate one or more characteristics associated with the signals and/or media streams. These rules may establish acceptable or threshold values or an acceptable operating range of values for the characteristics. The rules may be preselected with a predetermined operating range of values. The rules may also allow modifications to the operating range of values. In some embodiments, rules may be generated and/or configured by a technician or operator.

In some embodiments, the set of preconfigured rules associated with characteristics of the signals or media streams may be grouped based on specific elements or aspects of the signals or media streams, referred to as characteristic types. Exemplary sets of rules for input type characteristics, service type characteristics, session stream type characteristics, signal table type characteristics, program guide type characteristics, and RF interface type characteristics are shown respectively in Tables 1-6 below.

### Input

TABLE 1

| Rule Id | Rule |
|---|---|
| 1 | Non-boot multicast address defined on multiple PLPs |
| 2 | More than 4 PLPs defined for input |
| 3 | Carrier loss |
| 4 | Two or more conflicting service listing tables (SLTs) detected |
| 6 | Boot Address had data (bitrate > 0) |
| 7 | Non-standard boot address configured |
| 8 | studio to link transfer protocol (STLTP) mode |
| 9 | Can not bind to boot address multicast |
| 10 | Boot address must be PLP: ${plp} address: ${address} port: ${port} |
| 11 | Error binding an open socket to an interface, possibly because port in |
| | use |
| 12 | STLTP mode required |
| 13 | STLTP address must be: ${address} port: ${port} if STLTP is enabled |
| 14 | Bitrate must always be between ${min} and ${max} ${units} (inclusive) |
| 15 | Average bitrate (bps) must remain between ${min} and ${max} ${units} |
| | (inclusive) over ${time} seconds |
| 16 | Bitrate Bandwidths |
| 17 | Valid source addresses |
| 18 | Discarded packets |
| 19 | malformed packets |
| 20 | Non-signaling bitrate within ${bps} of calculated maximum (RF, STLTP) |
| 21 | Non-signaling bitrate within ${bps} of calculated max for a PLP (RF, |
| | STLTP) |
| 22 | Services do not have unique channel numbers |
| 23 | Services do not have unique ids |
| 24 | Number of total services must always be between ${min} and ${max} |
| | (inclusive) |
| 25 | Number of ROUTE services must always be between ${min} and ${max} |
| | (inclusive) |
| 26 | Number of MPEG Media Transport (MMT) services must always be |
| | between ${min} and ${max} (inclusive) |
| 27 | Valid service ids |
| 28 | service added |
| 29 | service deleted |
| 30 | service name changed |

TABLE 2

| Rule Id | Rule |
|---|---|
| 1 | Service not listed in guide |
| 2 | Service visibility must be ${state} |
| 3 | Service activity must be ${state} |
| 4 | Service protocol must be ${protocol} |
| 5 | Service must contain Video ${min} to ${max} (inclusive) streams |
| 6 | Service must contain Audio ${min} to ${max} (inclusive) streams |
| 7 | Service must contain Data ${min} to ${max} (inclusive) streams |
| 8 | Bitrate must always be between ${min} and ${max} ${units} (inclusive) |
| 9 | Average bitrate (bps) must remain between ${min} and ${max} ${units} (inclusive) over |
| | ${time} seconds |
| 10 | Bitrate Bandwidths |
| 11 | Content type session streams |
| 12 | Valid session stream ids |
| 13 | session stream added |
| 14 | session stream removed |
| 15 | session stream type changed |
| 16 | Unsignaled session stream messages (unsignaled TSI/packet ID) |

TABLE 3

| Rule Id | Rule |
|---|---|
| 1 | Content type must contain ${content} |
| 2 | Object number improperly incremented |
| 3 | Object number roll over detected |
| 4 | Object incomplete at presentation time |
| 5 | Total objects buffer size must be between ${min} and ${max} ${units} (inclusive) |
| 6 | Total number of objects must be between ${min} and ${max} (inclusive) |
| 7 | Active objects buffer size must be between ${min} and ${max} ${units} (inclusive) |
| 8 | Active objects must be between ${min} and ${max} (inclusive) |
| 9 | Expired objects buffer size must be between ${min} and ${max} ${units} (inclusive) |
| 10 | Expired objects must be between ${min} and ${max} (inclusive) |
| 11 | Object intervals |
| 12 | Route Init object intervals (if available) |
| 13 | Bitrate must always be between ${min} and ${max} ${units} (inclusive) |
| 14 | Average bitrate (bps) must remain between ${min} and ${max} ${units} (inclusive) over |
| | ${time} seconds |
| 15 | Bitrate Bandwidths |
| 16 | A packet for an object was received before an SLS for the TSI |
| 17 | A duplicate packet (segment) for an object was received |
| 18 | The signaled object size changed while receiving packets for the object |
| 19 | A packet for an object was received out of order (possibly due to a previous fragment being |
| | lost) |
| 20 | A packet was received with no payload |
| 21 | A packet (segment) was received that extends beyond the end of the signaled message size |
| 22 | new AEA message received |
| 23 | AEA updated/canceled |
| 24 | AEA message expired and not canceled |
| 25 | non-real time (NRT) object took longer than ${secs} to complete |
| 26 | still video frame for ${secs} or longer |
| 27 | silent audio for ${secs} or longer |

TABLE 4

| Rule Id | Rule |
|---|---|
| 1 | Message decoding error |
| 2 | Improper version change detected |
| 3 | Message data changed without version number update |
| 4 | SLT Detected |
| 5 | SLS Detected (route) |
| 6 | For ROUTE, Every Signaled SLS in SLT Detected |
| 7 | For MMT, Every Signaled service in SLT must have associated USD and MPT |
| 8 | STT Detected (optional, disabled by default) |
| 9 | MPT Detected (mmt) |
| 10 | USD Detected (MMT) |
| 11 | HRBM Detected (mmt) |
| 12 | HRBM_RM Detected (mmt) |
| 13 | LMT detected (rf & stltp) |
| 14 | SLT Message Intervals |
| 15 | SLS Message Intervals |
| 16 | STT Message Intervals |
| 17 | EFDT Message Intervals |
| 18 | MPT Message Intervals |
| 19 | USD Message Intervals |
| 20 | HRBM Message Intervals |
| 21 | HRBM RM Message Intervals |
| 22 | SLS mismatched URI |
| 23 | SLS Missing content Info |
| 24 | SLS Missing Representation |
| 25 | SLS Missing S-TSID |
| 26 | SLS Missing USBD |
| 27 | SLT missing ESG service |
| 28 | SLT missing one or more mandatory parameters |
| 29 | SLT contains multiple services with same IP/port/source configuration |
| 30 | STT missing one or more mandatory parameters |
| 31 | USD missing one or more mandatory parameters |

TABLE 5

| Rule | |
|---|---|
| ID | Rule |
| 2 | Programs in the guide overlap |
| 3 | Programs in the guide are not contiguous |
| 4 | Program guide must cover current time |
| 5 | Program guide has data for ${amount} ${units} |
| | before current time |
| 6 | Program guide has data for ${amount} ${units} |
| | after current time |
| 7 | Program guide must contain at |
| | least ${amount} ${units} of data |
| 8 | SGDD Not Detected |
| 9 | SGDU Not Detected |
| 10 | Active services in guide are detected in the system |
| 11 | Inactive services ${req} be listed in the guide |
| 12 | Hidden services ${req} be listed in the guide |

TABLE 6

| Rule ID | Rule |
|---|---|
| 1 | Modulation Error Rate must remain between ${min} and ${max} (inclusive) |
| 2 | RF Level must remain between ${min} and ${max} (inclusive) |
| 3 | Malformed Packets must remain between ${min} and ${max} (inclusive) |
| 4 | Discarded Packets must remain between ${min} and ${max} (inclusive) |
| 5 | LDPC Bit Error Rates must remain between ${min} and ${max} (inclusive) |
| 6 | BCH Frame Error Rates must remain between ${min} and ${max} (inclusive) |
| 7 | Max LDPC Iterations must remain between ${min} and ${max} (inclusive) |
| 8 | Average LDPC Iterations must remain between ${min} and ${max} (inclusive) |
| 9 | SNR must remain between ${min} and ${max} (inclusive) |
| 10 | Dektec device cant be attached, possibly because the device is already in use |
| 11 | Connector on Dektec device can't be used, possibly because the number in invalid |
| 12 | The supplied demodulation parameters are invalid/rejected by the Dektec board |
| 13 | The supplied frequency is invalid/rejected by the board |
| 14 | The IP header in a received ALP packet indicates a payload larger than the actual size of the |
| | message |
| 15 | The UDP header in a received ALP packet exceeds the message size |
| 16 | FIFO Overflowed |
| 17 | FIFO Overflow abated |

The rules available for the monitored characteristics in diagnostic device 200 may also establish what happens when the values of the characteristics are outside the acceptable range. In some embodiments, a series of severity levels may be provided to the technician or operator through, for instance, user interface 270 or on a display connected to output interface 280. The severity levels may be color coded. An exemplary set of severity levels and corresponding color indicator is shown below:

| | |
|---|---|
| Severity level: Information | Color: Green |
| Severity level: Noncompliance with Standard | Color: Blue |
| Severity level: Warning (QOS issues) | Color: Yellow |
| Severity level: Error (issues with equipment, receivers) | Color: Orange |
| Severity level: Critical (significant problems) | Color: Red |
| Severity level: Fatal (technically of the air) | Color: Black |

In an exemplary embodiment of the operation of diagnostic device 200 in response to monitoring and processing the two media streams in accordance with the Rule ID 6, “Total number of objects must be between $ {min} and $ {max} (inclusive)”, as defined in Table 2, a predetermined status is assigned to the defined severity levels between a minimum and maximum value as listed below:

| Level | Conditions |
|---|---|
| FATAL | min = 0, max = 0 |
| WARNING | min = 1, max = 2 |
| INFORMATION | min = 3, max = 6 |
| WARNING | min = 7, max = 9 |
| ERROR | min = 10, max = 20 |
| CRITICAL | min = 21, max =50 |

As an example of operation, the diagnostic device 200 may detect a FATAL or CRITICAL state level for a characteristic for a media stream when monitoring the media stream at a first location in the communication system (exciter 165 in FIG. 1). The diagnostic device 200 may detect a less severe level (e.g., INFORMATION, WARNING, or ERROR) for the same media stream at a second location in the communication system (e.g., exciter 115). As a result of the detection of the different levels for the characteristics, diagnostic device 200 may send a control signal to switch a control element in a device in the communication system (e.g., broadcast gateway 110 or gateway device 160) to start using the media stream that is present at the second location in place of the media stream that is present at the first location.

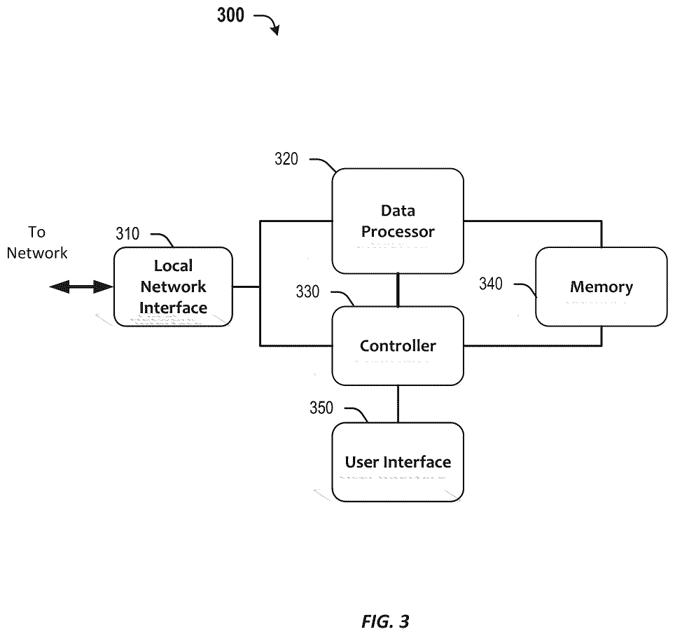

FIG. 3 illustrates a block diagram of an exemplary gateway 300 used in a broadcast content distribution system according to aspects of the present disclosure. Gateway 300 provides data routing and formatting capabilities as part of a broadcast signal distribution system, including a broadcast repeater system similar to that described in FIG. 1. Gateway 300 may operate in a manner similar to gateway 160 described in FIG. 1. Gateway 300 may further share some or all of the same functional and/or operational capability with broadcast gateway 110 and/or transport multiplexer 130. In gateway 300, one or more content streams are received from a processing device connected as part of a local network, such as broadcast gateway 110, through local network interface 310. Local network interface 310 is coupled to both data processor 320 and controller 330. Both data processor 320 and controller 330 are coupled to memory 340. Controller 330 is coupled to both data processor 320 and user interface 350. Signals and data from data processor 320 and controller 330 are provided to local network interface 310 for transmission to another processing device connected as part of the local network, such as an exciter (e.g., exciter 115 or exciter 165 in FIG. 1). It is worth noting that some elements or components that may be necessary for proper operation of gateway 300 are not shown or described here for the sake of conciseness as they are well known to those skilled in the art.

Local network interface 310 includes circuitry to perform local network signal processing functions for transmitting and receiving signals as part of communication with another device in the broadcast signal distribution system (e.g., transceiver 155 or exciter 165 in FIG. 1). The signal processing functions in local network interface 310 may include those used for local networks as described above for signal interface 210 or local network interface 230 in FIG. 2. Local network interface 310 also includes an interface connector suitable for the type of communication medium used with the local network as described above for local network interface 230. In some embodiments, local network interface may be configured specifically for interfacing to other broadcast devices in the broadcast content distribution system 100 (e.g., studio content processing system 105 and exciter 115).

Processor 320 receives data from, and provides data to, the local network interface based on the type of communication between gateway 300 and other devices in the network. Processor 320 may analyze the data it receives and/or processes, aggregate the received data where possible, and route the processed data to its final destination, either directly or indirectly. Controller 330 receives status information about operation of gateway 300 as well as information about the data that is provided to, and delivered from, processor 320. Controller 330 may also receive control instructions for specific operation and processing or requests for status to be performed in gateway 300 from external devices in the network (e.g., broadcast gateway 110 in FIG. 1). Controller 330 processes the instructions or requests and provides the necessary control information to processor 320 to perform the specific operation and processing of data.

It is worth noting that one or both of data processor 320 and controller 330 may be embodied as a programmable microprocessor that is reconfigurable with downloadable instructions or software code stored in memory 340. One or both of data processor 320 and controller 330 may alternatively be a specifically programmed controller and data processor with internal control code for controlling, managing, and processing all functions and data in gateway 300. Further, data processor 320 and controller 330 may be combined to form a single processing element and further embodied as described here.

Memory 340 supports storage of programming instructions and data associated with the control and operation of the gateway 300 through data processor 320 and controller 330. Memory 340 may include one or more of the following storage elements including, but not limited to, RAM, ROM, EEPROM, and flash memory. User interface 350 may include some form of user notification mechanism to show device functionality or status, such as indicator lights, a speaker, or a display. User interface 350 may also include circuitry for converting data received from controller 330 into signals that may be used to operate the user notification mechanism. User interface 350 may also include one or more buttons for performing specific user operations such as device reset, device configuration clear, and/or device access set-up.

In operation, gateway 300 is configured to operate in a first operating mode as part of the operation of broadcast content distribution system 100. The first operating mode includes receiving a first media stream from a first content source through another broadcast device, such as studio content processing system 105. The first media stream may be selected from a plurality of available media streams from a plurality of content sources. The first operating mode also includes processing the first media stream and providing the processed first media stream for broadcast transmission through other broadcast devices, such as exciter 115, transmitter 120, and transmitter antenna 125. The gateway 300 is also configured to receive one or more control signals from the broadcast communication network. The control signals may be generated and provided by a diagnostic device, such as diagnostic device 200 described in FIG. 2. The gateway 300 is also configured to operate in a second operating mode in response to the control signals. The second operating mode is different from the first operating mode.

In some embodiments, the second operating mode may include replacing the first media stream with a second media stream. The second media may be from a second content source. The second media stream may further be selected from at least one of the plurality of available media streams from a plurality of content sources. The second media stream may also contain media content, data content, and/or information that is substantively similar or substantively identical with the first media stream. In this context, substantively similar or substantively identical content may include, but is not limited to, content that is identical to the content that is in the media stream but may have been processed or formatted differently, such as different video compression level, error correction coding level, signal modulation, and the like. In this manner, the content in the media stream is the same, while information around or associated with the content in the media stream may not be the same. In some situations, the second media stream may be the same as, or identical to, the first media stream. The second operating mode may also include processing the second media stream and providing the second media stream for broadcast transmission as described earlier.

In some embodiments, the second operating mode may include modifying one or more transmission parameters associated with the first media stream prior to providing the first media stream for broadcast transmission. The adjustments may be based on information received from the control signals. The modifications may include adjustments to the transmission parameters that may be used to increase the reception performance of a broadcast signal containing the first media stream when received by at least one broadcast signal receiver located within a geographic region covered by the broadcast transmission. Examples of transmission parameters include, but are not limited to, low density parity check (LDPC) encoding rate, Bose, Ray-Chaudhuri and Hocquenghem (BCH) encoding rate, interleaver depth, modulation depth, and fast fourier transform (FFT) size.

It is important to note that some or all of the operational aspects described for gateway 300 may also apply to the operation of other broadcast devices in a broadcast communication system. For example, a transmitter, such as transmitter 120, may be configured to switch between providing a first media stream in a first operating mode and providing a second media stream in place of the first media stream in a second operating mode based on receiving a control signal. Further, gateway 300, or any other broadcast device, may receive a control signal and process the control signal. Information extracted or generated from the processed control may be further provided over the broadcast communication network to a different broadcast device in order to change the operating mode in that broadcast device.

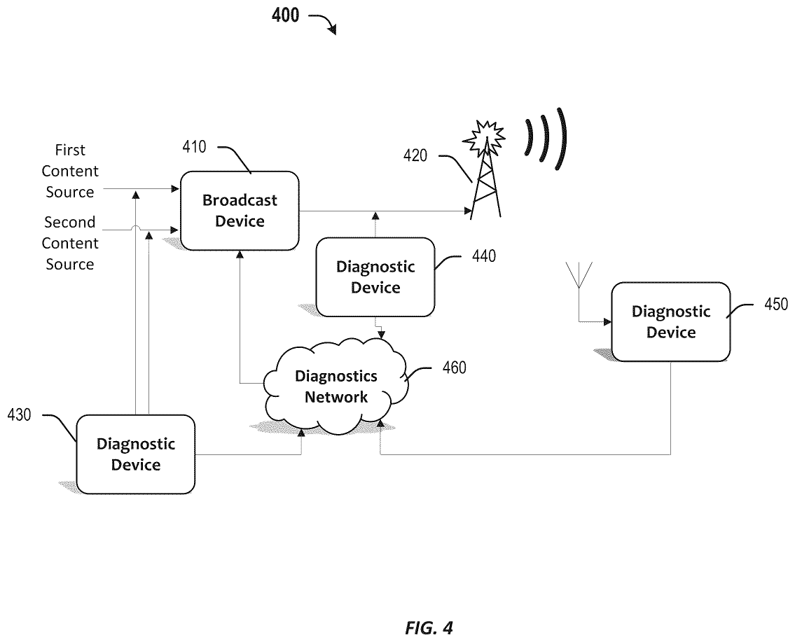

FIG. 4 shows an exemplary signal diagnostic system 400 used as part of a broadcast communication system, such as broadcast content distribution system 100, according to aspects of the present disclosure. Signal diagnostic system 400 represents a specific configuration of diagnostics devices coupled into, and communicating with, at least one broadcast device included in a broadcast communication system. In signal diagnostic system 400, a first media stream from a first content source and a second media stream from a second content source are provided to broadcast device 410. Broadcast device 410 may be any type of broadcast device included in the broadcast communication system including, but not limited to, gateways, exciters, and transmitters. The output of broadcast device 410 is coupled, either directly, or through other broadcast devices, to transmitter antenna 420. A diagnostic device 430 is also coupled to both the first media stream and the second media stream at a location either before or at the input of broadcast device 410. A diagnostic device 440 is coupled to the output signal either at the output of broadcast device 410 or at any communication point after broadcast device 410 and before transmitter antenna 420. A diagnostic device 450 is geographically located within reception range of the broadcast signal transmitted from transmitter antenna 420. Diagnostic devices 430, 440, and 450 are coupled to diagnostics network 460. Diagnostics network 460 is further coupled to broadcast device 410. Except as noted below, broadcast device 410, transmitter antenna 420, and diagnostic devices 420, 440, and 450 operate in a manner similar to those same devices described earlier.

In operation, broadcast device 410 is configured to operate in a first mode of operation. In the first mode of operation, broadcast device 410 receives a first media stream from a first content source, processes the first media stream, and provides the first media stream for broadcast transmission through transmitter antenna 420. Broadcast device 410 may also receive a second media stream from a second content source but does not process the second media stream when operating in the first mode of operation. Diagnostic device 430 monitors one or more characteristics associated with the first media stream. Diagnostic device 430 may also monitor one or more characteristics associated with the second media stream. Further, diagnostic device 440 monitors one or more of the same characteristics associated with the first media that is provided from broadcast device 410 in the first mode of operation. Additionally, diagnostic device 450 may receive the broadcast signal from transmitter antenna 420 and monitor one or more characteristics associated with the first media stream included in the broadcast signal.

One or more of the diagnostic devices 430, 440, and 450 may provide data related to the monitored characteristics through the diagnostics network 460. In some embodiments, the data may be in the form of one or more control signals that are generated when one or more of the values for the monitored characteristics exceeds a threshold value or is otherwise outside of a predetermined range of operation. The data and/or control signals may be provided to any of the devices connected to the diagnostics network 460. The data and/or control signals provided on the diagnostic network 460 may be further processed by one of the diagnostic devices 430, 440, 450 or by another device to generate one or more control signals that are provided to broadcast device 410 over diagnostics network 460.

Broadcast device 410, in response to receiving the one or more control signals over diagnostic network 460, is configured to operate in a second operating mode. In the second operating mode, broadcast device 410 replaces the first media stream with the second media stream received from the second content source, processes the second media stream, and provides the second media stream for broadcast transmission through transmitter antenna 420.

It is worth noting that diagnostics network 460 provides connectivity and communication between diagnostics devices 430, 440, and 450 as well as broadcast device 410 in a manner that is different from the broadcast communication network form by a broadcast communication (e.g., broadcast content distribution system 100 in FIG. 1). Diagnostics network 460 may be referred to as an enterprise network. Enterprise networks are typically configured to provide communication of information that is not meant to be used by the general public. In FIG. 4, diagnostics network 460 uses enterprise network principles to provide private back office, or return channel, communications for diagnostic device 450 that normally cannot bidirectionally communicate with, for instance, diagnostics devices 430 and 440. All or a portion of diagnostics network 460 may also be incorporated into, or utilize a portion of, the broadcast communication network. Further, diagnostics network 460 may utilize a communication platform or protocol in order to further maintain privacy and security. In some embodiments diagnostics network 460 may utilize a broadcast services management platform (BSMP). BSMP defines a set of software processes or modules configured to dynamically manage or control a plurality of content distribution channels. Data and information to be distributed over diagnostics network 460 may include support files and other data provided by diagnostic devices 430, 440, and 450.

In some embodiments, it may be advantageous to have more than one of the diagnostic devices 430, 440, and 450 that can provide inputs to, create, and/or modify the same control signal. In this manner, signal diagnostic system 400 may include some form of arbitration scheme of the content provided from the plurality of diagnostic devices for generating and providing the control signal. The arbitration may involve, but is not limited to, a scheme in which one diagnostic device is designated as the “primary” device and the other diagnostic devices are designated as “secondary” devices. Alternatively, a different device in signal diagnostic system 400, such as a network processor (not shown), may serve as an arbiter for the plurality of diagnostic devices and manage generating and providing of the control signal. Regardless of the arbitration scheme utilized, a single diagnostic device or arbiter device may be responsible for the control signal.

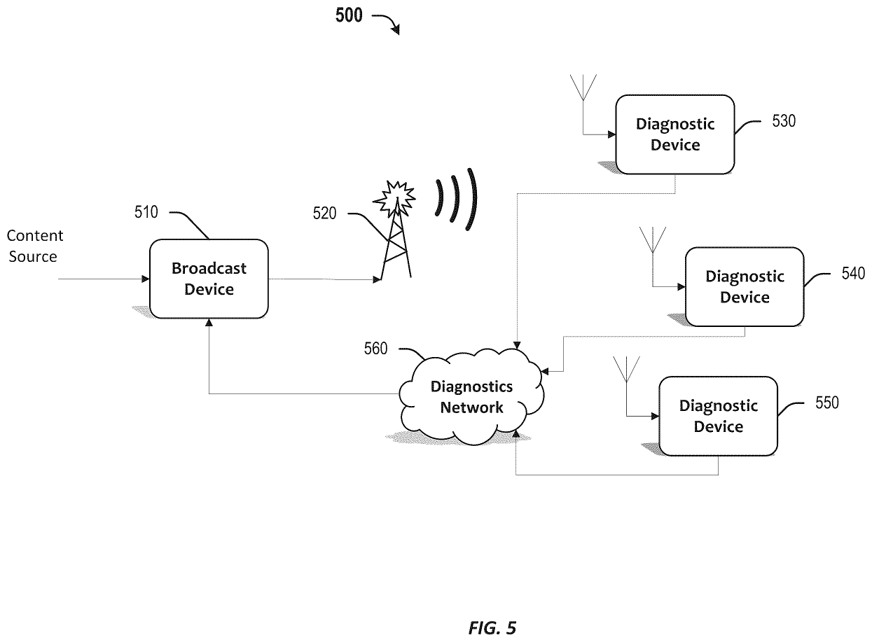

FIG. 5 shows another exemplary signal diagnostic system 500 used as part of a broadcast communication system, such as broadcast content distribution system 100, according to aspects of the present disclosure. Signal diagnostic system 500 represents another specific configuration of diagnostics devices coupled into, and communicating with, at least one broadcast device included in a broadcast communication system. In signal diagnostic system 500, a media stream from a first content source is provided to broadcast device 510 in a manner similar to that described in FIG. 4. The output of broadcast device 510 is coupled, either directly, or through other broadcast devices, to transmitter antenna 420. A diagnostic device 430 is geographically located at a first location within reception range of the broadcast signal transmitted from transmitter antenna 520. A diagnostic device 540 is geographically located at a second location within reception range of the broadcast signal transmitted from transmitter antenna 520. A diagnostic device 550 is geographically located at a third location within reception range of the broadcast signal transmitted from transmitter antenna 520. Diagnostic devices 530, 540, and 550 are coupled to diagnostics network 560. Diagnostics network 560 is further coupled to broadcast device 510. Except as noted below, broadcast device 510, transmitter antenna 520, and diagnostic devices 530, 540, and 560 operate in a manner similar to those same devices described earlier.

In operation, broadcast device 510 is configured to operate in a first mode of operation. In the first mode of operation, broadcast device 510 receives a first media stream from a first content source, processes the first media stream, and provides the first media stream for broadcast transmission through transmitter antenna 520. Each one of diagnostic device 530, diagnostic device 540, and diagnostic device 550 monitors one or more characteristics associated with the first media stream from each of their geographic locations. Each of the diagnostic devices 530, 540, and 550 may provide data related to the monitored characteristics through the diagnostics network 560. In some embodiments, the data may be in the form of one or more control signals that are generated when one or more of the values for the monitored characteristics exceeds a threshold value or is otherwise outside of a predetermined or operator defined range of operation. The data and/or control signals may be provided to any of the devices connected to the diagnostics network 560. The data and/or control signals provided on the diagnostic network 560 may be further processed by one of the diagnostic devices 530, 540, 550 or by another device to generate one or more control signals that are provided to broadcast device 510 over diagnostics network 560.

Broadcast device 510, in response to receiving the one or more control signals over diagnostic network 560, is configured to operate in a second operating mode. In the second operating mode, broadcast device 510 modifies one or more transmission parameters associated with the first media stream prior to providing the first media stream for broadcast transmission through transmitter antenna 520. The modification of the transmission parameters may be made to improve reception of the broadcast signal, as described above and, in particular, reception at one or more of the geographic locations for diagnostic devices 530, 540, 550. In some embodiments, the broadcast device 500 may not be capable of modifying the transmission parameters in the first media stream. In these cases, broadcast device 500 may determine the modification and include the information associated with the modification in the signaling protocol of the first media stream in order to allow another broadcast device (not shown) in the signal diagnostic system to modify the first media stream.

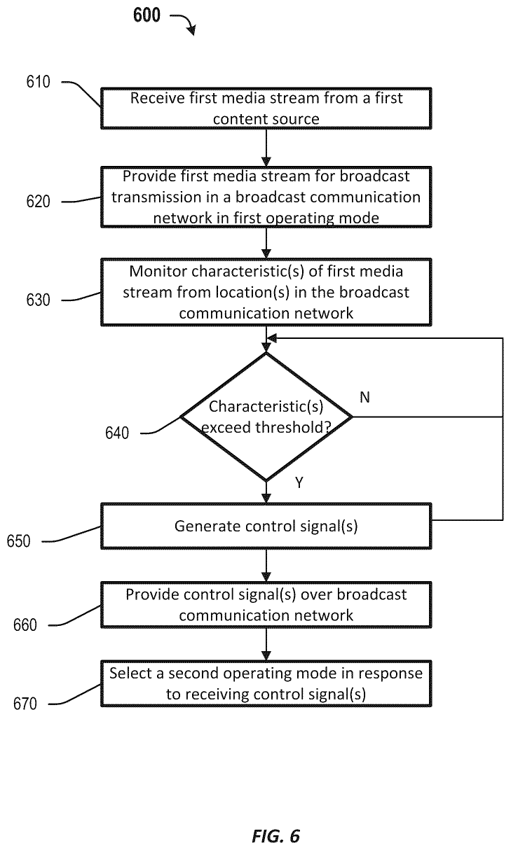

FIG. 6 illustrates a flow chart of an exemplary process 600 for visual monitoring media streams in a signal communication system according to aspects of the present disclosure. Process 600 will be primarily described with respect to broadcast content distribution system 100 described in FIG. 1. One or more aspects of process 600 may apply to a diagnostic device, such as broadcast content diagnostic device 190 or diagnostic device 200 described in FIG. 2. Further, one or more of the steps of process 600 may apply to a broadcast device, such as broadcast gateway 110, exciter 115, or transmitter 120, as well as gateway 300 described in FIG. 4. Also, one or more aspects of process 600 may equally apply to signal diagnostic system 400 described in FIG. 4 as well as signal diagnostic system 500 described in FIG. 5. Although process 600 depicts steps performed in a particular order for purposes of illustration and discussion, the operations discussed herein are not limited to any particular order or arrangement.

At step 610, a first media stream from a first content source is received at a broadcast device. The media stream may be composed of audio/video content as well as ancillary information such as program or service tables and/or program guide data. The received media stream may be part of one or more signals that are communicated within a broadcast communication network in broadcast content distribution system 100. The media stream may be any one or more of elementary streams, service streams, transport streams, or phy layer streams as described above. For example, the media stream may be a service stream that complies with the ATSC 3.0 standard. Also, at step 610, the broadcast device may process the first media stream as described earlier.

At step 620, the first media stream, received at step 610, is provided for broadcast transmission broadcast device while operating in a first operating mode. The first media stream may be provided for broadcast transmission by transmitter antenna 125 either directly, or indirectly through other broadcast devices, using the broadcast communication network.

At step 630, at least one characteristic associated with the quality of the first media stream is accessed or received and monitored by one or more diagnostic devices (e.g., broadcast diagnostic device 190) from at least one location in the broadcast communication network. The first media stream may be accessed or received via a wired or wireless connection to the broadcast communication network. Examples of characteristics include, but are not limited to, bit rate, modulation error rate, signal to noise ratio, bit error rate, bitrate bandwidth, missing content, content synchronization, and number of discarded packets. The monitoring further includes determining values for the characteristic using the data from the first media stream. The characteristics may be preselected or may be selected by a technician or operator. The input from the technician or operator is entered through a user input device connected to a user interface (e.g., user input interface 270 in FIG. 2) and provided to a processor (e.g., processor 240). In some embodiments, the characteristics are incorporated into rules that are used to establish threshold values and/or an operating range for the characteristics, as described above.

At step 640, a determination is made as to whether or not a value for at least one characteristic exceeds a threshold value. The threshold value may be preselected or may be selected by the technician or operator as part of the incorporation of rules for the characteristics as described above. The determination may be performed by a processor or controller in the diagnostic device (e.g., processor 240 in FIG. 2) as part of the monitoring performed at step 630.

If, at step 640, the determination is made that the value for at least one characteristic exceeds the threshold value, then, at step 650, one or more control signals are generated. The control signal(s) may be generated by a processor or controller in the diagnostic device (e.g., processor 240 in FIG. 2). In some embodiments, the control signal may be a single or plural binary level signal providing control information. In other embodiments, the control signal may contain additional information that requires additional processing in a broadcast device.

At step 660, the one or more control signals are provided over the broadcast communication network. The control signal(s) may be provided by the diagnostic device through a network interface (e.g., signal interface 210 or local network interface 230). In some embodiments, the control signal(s) may be provided through a diagnostics network that is incorporated as part of the broadcast communication network as described above.

After the control signal is provided over the broadcast communication network or if the determination is made, at step 640, that the value for the at least one characteristic does not exceed the threshold value, process 600 returns to step 640 to further determine if a new value for a characteristic monitored at step 630 exceeds a threshold value.

At step 670, a second operating mode that is different from the first operating mode is selected in response to receiving at least one control signal from the broadcast communication network at the broadcast device. In some embodiments, the second operating mode in the broadcast device includes replacing the first media stream with a second media stream and providing the second media stream for broadcast transmission. The second media may be from a second content source and/or may contain redundant content as described above. In some embodiments, the second operating mode modifies one or more transmission parameters associated with the first media stream prior to providing the first media stream for broadcast transmission.

It is worth noting that one or more of the steps of process 900 may be modified, steps may be added or omitted depending on a specific embodiment. In some embodiments, the second media stream may also be accessed or received and monitored at step 630, as described above. The second media stream may further be accessed or received via a wired or wireless connection to the broadcast communication network. In some embodiments, the monitoring, at step 630, can include monitoring the first media stream using a plurality of diagnostic devices located at different locations in the broadcast communication network, including different geographic locations, as described above. Further, at step 640, the determination may be performed based on information provided from each of the diagnostic devices. For example, a numerical count may be maintained for each instance of a value outside an operating range threshold from any of the diagnostic devices. The determination, at step 640 may be based on the numerical count exceeding a threshold. Additionally, a separate control signal may be generated and provided by each of the diagnostic devices, at steps 650 and 660 respectively.

It is to be appreciated that although the embodiments described above focus on physical hardware and elements within a signal communication system, the principles of the present disclosure may be easily extended to implementations that involve software based programming that are stored in a computer readable medium, such as a magnetic optical based storage structure. Further, in some embodiments, one or more of the elements of a process based on the principles of the present disclosure, such as process 900 described may be implemented utilizing cloud-based operations and/or storage. It is to be appreciated that, except where explicitly indicated in the description above, the various features included as part of the principles of the present disclosure can be considered cumulative and interchangeable, that is, a feature shown in one embodiment may be incorporated into another embodiment.

Although embodiments which incorporate the teachings of the present disclosure have been shown and described in detail herein, those skilled in the art can readily devise many other varied embodiments that still incorporate these teachings. Having described preferred embodiments for system and method for controlling the delivery of broadcast content, it is noted that modifications and variations can be made by persons skilled in the art in light of the above teachings. It is therefore to be understood that changes may be made in the particular embodiments of the disclosure which are within the scope of the disclosure as outlined by the appended claims.

1. A system for controlling delivery of broadcast content, comprising:
a broadcast device coupled to a broadcast communication network, including a transmitter, the broadcast device configured to operate in a first broadcast operating mode, the first operating mode including receiving a first media stream from a first content source and providing the first media stream for broadcast transmission;
at least one diagnostic device coupled to the broadcast communication network, the at least one diagnostic device configured to:
receive the first media stream from at least one location in the broadcast communication network;
monitor at least one characteristic of quality of the at least one media stream;
generate at least one control signal in response to a determination that a value for the at least one characteristic exceeds a threshold value; and
provide the at least one control signal to the broadcast device over the broadcast communication network;
wherein the broadcast device is further configured to operate in a second broadcast operating mode in response to receiving the at least one control signal, the second broadcast operating mode being different from the first broadcast operating mode.

2. The system of claim 1, wherein the broadcast device, in the second broadcast operating mode, is further configured to:
replace the first media stream with a second media stream; and
provide the second media stream for broadcast transmission.

3. The system of claim 2, wherein the diagnostic device is further configured to receive the second media stream from at least one location in the broadcast communication network.

4. The system of claim 2, wherein the second media stream is from a second content source.

5. The system of claim 2, wherein the second media stream is selected from at least one of a plurality of available media streams from a plurality of sources.

6. The system of claim 2, wherein the first media stream and the second media stream contain substantively similar content.

7. The system of claim 6, the first media stream and the second media stream are the same media stream received from a single source but selected at different points in the transmission path.

8. The system of claim 2, wherein at least one of the first media stream and the second media stream is received via one of a wireless connection and a wired connection.

9. The system of claim 1, wherein the at least one diagnostic device is coupled to the broadcast communication network by at least one of a wireless connection and a wired connection.

10. The system of claim 1, wherein the at least one characteristic of quality is selected by a user of the diagnostic device.

11. The system of claim 1, wherein the at least one characteristic includes at least one of bit rate, modulation error rate, signal to noise ratio, bit error rate, bitrate bandwidth, missing content, content synchronization, and number of discarded packets.

12. The system of claim 1, wherein the threshold value is determined based on an operating range selected by a user for the at least one characteristic.

13. The system of claim 1, wherein the broadcast device, in the second broadcast operating mode, is further configured to modify a transmission parameter associated with the first media stream prior to providing the first media stream for broadcast transmission.

14. The system of claim 132, wherein the at least one characteristic of quality is assigned a number if it is determined that it is outside of the user defined operating range and wherein the broadcast device is only configured to operate in the second operating mode if the sum of the numbers is greater than a threshold.

15. The system of claim 132, wherein the at least one diagnostic device further comprises:
a first diagnostic device, located at a first geographic location, configured to monitor the at least one characteristic of the quality of the broadcast transmission containing the first media stream at the first geographic location and generate a first control signal in response to a determination that the at least one characteristic is outside of the user defined operating range;
a second diagnostic device, located at a second geographic location configured to monitor the at least one characteristic of the quality of the broadcast transmission containing the first media stream at the second geographic location and generate a second control signal in response to a determination that the at least one characteristic is outside of the user defined operating range; and
wherein the broadcast device, in response to receiving the first and second control signals, adjusts the at least one transmission parameter associated with the first media stream in the broadcast device.

16. The system of claim 15, wherein the adjusting of the at least one transmission parameter increases reception performance of a broadcast signal containing the first media stream when received by at least one broadcast signal receiver located within a geographic region covered by the broadcast transmission.

17. The system of claim 13, wherein the at least one transmission parameter includes at least one of low density parity check encoding rate, Bose, Ray-Chaudhuri and Hocquenghem encoding rate, interleaver depth, modulation depth, and fast fourier transform size.

18. The system of claim 1, wherein the broadcast device includes at least one of a studio content processing system, broadcast gateway, and exciter, a transmitter, and a transmitter antenna.

19. A method for controlling delivery of broadcast content, comprising:
receiving a first media stream from a first content source;
providing the first media stream for broadcast transmission in a broadcast communication network while operating in a first broadcast operating mode;
monitoring at least one characteristic of the quality of the first media stream from at least one location in the broadcast communication network;
generating at least one control signal in response to a determination that a value for the at least one characteristic exceeds a threshold value;
providing the at least one control signal over the broadcast communication network; and
selecting a second broadcast operating mode in response to receiving the at least one control signal, the second broadcast operating mode being different from the first broadcast operating mode.

20. The method of claim 19, wherein the second broadcast operating mode includes replacing the first media stream with a second media stream and providing the second media stream for broadcast transmission.
